(19) United States
(12) Patent Application Publication
(10) Pub. No.: US 2025/0379329 A1
(43) Pub. Date: Dec. 11, 2025

(54) SYSTEMS AND DEVICES FOR PROTECTING BATTERIES

(71) Applicant: Viridi Parente, Inc., Buffalo, NY (US)

(72) Inventors: Phillip Partin, Grafton, MA (US); Jan-Roger Linna, Boston, MA (US); John Paul Vance, Amherst, NY (US); Noah S. Podolefsky, Boulder, CO (US)

(21) Appl. No.: 19/233,005

(22) Filed: Jun. 10, 2025

Related U.S. Application Data
(60) Provisional application No. 63/658,063, filed on Jun. 10, 2024.

(51) Int. Cl. H01M 50/383; H01M 10/0525; H01M 10/658; H01M 50/213; H01M 50/24; H01M 50/258; H01M 50/30; H01M 50/342; H01M 50/548; H01M 50/682

(52) U.S. Cl. CPC H01M 50/383; H01M 10/0525; H01M 10/658; H01M 50/213; H01M 50/24; H01M 50/258; H01M 50/3425; H01M 50/394; H01M 50/548; H01M 50/682

(57) ABSTRACT

Lithium-ion batteries, battery modules and battery packs are provided that comprise anti-propagation systems designed to mitigate a thermal runaway condition. A battery module comprises a housing comprising a plurality of lithium-ion battery cells each having a positive terminal and a negative terminal, and a flexible container housing a liquid and positioned adjacent to the positive terminal of at least one of the battery cells. The flexible container comprises a material configured to melt at a temperature at or above a threshold temperature for quenching a thermal runaway event in the battery pack to prevent the thermal runaway from propagating and spreading to other battery cells or modules within the pack. The battery module comprises a reinforcement substrate secured to the flexible container. The reinforcement substrate provides structural rigidity to the flexible container and functions to inhibit thermal runaway eject from passing therethrough to other battery modules within the battery pack.

### CROSS-REFERENCE TO RELATED APPLICATIONS

This application claims the benefit of U.S. Provisional Application Ser. No. 63/658,063, filed Jun. 10, 2024, the complete disclosure of which is incorporated herein by reference for all purposes.

### TECHNICAL FIELD

This description generally relates to batteries and more particularly to lithium-ion batteries comprising anti-propagation systems designed to moderate thermal runaway conditions.

### BACKGROUND

Lithium-ion batteries (LIBs) are considered to be one of the most promising energy sources for many applications, such as energy storage and electric vehicles, owing to their high efficiency, high energy density, and long-life cycle. However, with the increase in cell capacity packaged within a given volume, there is an increased risk associated with thermal runaway in such batteries. Thermal runaway is an uncontrollable exothermic reaction that can occur within lithium-ion batteries when damaged or short circuited, resulting in a rapid release of heat. Thermal runaway occurs when an individual battery cell has reached a temperature at which the temperature will continue to increase on its own and thus becomes self-sustaining as the battery cell creates oxygen to feed the fire.

Thermal runaway reactions occurring in LIB cells often lead to gas-phase reactions involving volatile gases like hydrocarbons and generate additional heat resulting in the propagation of thermal failure. If the temperature of a LIB cell reaches the onset temperature for thermal runaway, usually around 160° C., exothermic reactions such as SEI layer decomposition, reduction of metal-oxide electrode material, and electrolyte decomposition occur. This results in abrupt increase of cell temperature, generation of internal volatile gases and pressure build-up within the cell. When the temperature of the released gas reaches its autoignition temperature, exothermal reactions happen

During thermal runaway, the battery can rapidly reach temperatures greater than 700° C. This heating breaks down the materials in the battery into a mixture of toxic and flammable gases. These gases could ignite and result in flames or explosion. Moreover, the heat released by the battery can propagate to adjacent batteries, resulting in a chain reaction. Systems including large stacks of batteries can suffer from a catastrophic cascade, resulting in considerable damage, pollution and potentially loss of life.

It would therefore be desirable to provide improved devices and systems for mitigating and/or preventing thermal runaway in lithium-ion batteries.

### SUMMARY

Lithium-ion batteries, battery modules and battery packs are provided that comprise anti-propagation systems designed to mitigate, inhibit, or prevent a thermal runaway condition. The anti-propagation systems include a passive system for quenching a thermal runaway event to prevent the thermal runaway from propagating and spreading to other battery cells or modules within the pack.

In one aspect, a battery module comprises a housing comprises a plurality of lithium-ion battery cells each having a positive terminal and a negative terminal, and a flexible container housing a liquid and positioned adjacent to the positive terminal of at least one of the battery cells. The flexible container comprises a material configured to melt at a temperature at or above a threshold temperature to expose the liquid to the positive terminal of the battery cell. The battery module comprises a reinforcement substrate in contact with the flexible container.

In various embodiments, the battery cells are oriented substantially vertically such that the positive terminals generally face upwards. The flexible container is disposed adjacent to, but spaced above, the positive terminals of the battery cells. Positioning the liquid containers directly above the positive terminals of the battery cells optimizes the system's ability to quench a thermal runaway condition that results in a breach through the cell's safety vent, which is typically located in the positive terminal.

In various embodiments, the reinforcement substrate is bonded to the flexible container such that the flexible container is disposed between the reinforcement sheet and the battery cells. The reinforcement substrate is substantially rigid and provides structural rigidity to the flexible container. In addition, the substrate serves to inhibit thermal runaway eject from passing therethrough to other battery modules within the battery pack.

The reinforcement substrate may comprise any suitable material that is non-combustible and produces little to no smoke and has low toxicity. The substrate preferably has a self-ignition temperature of greater than about 500° C., or greater than about 600° C. or greater than about 1,000° C. In certain embodiments, the reinforcement substrates may be formed of any suitably heat resistant material, such as, but not limited to, paper-phenolic laminate, fabric-phenolic laminate, ceramic or glass fiber laminate, carbon fiber laminate, ceramic or glass fiber paper, or other thermal insulating material, or a combination thereof. In an exemplary embodiment, the substrate comprises a phenolic material, such as a phenolic resin.

In other embodiments, the reinforcement substrate may comprise another substantially rigid material, such as metal, hard plastic or the like. The rigid material may include a coating or thin layer of heat resistant material. In an exemplary embodiment, the rigid material comprises a component of the housing, such as an interior wall of the housing, or an interior partition, layer or sheet within the housing. In one such embodiment, the flexible container is directly adhered to an inner surface of the housing, such that the housing serves as the reinforcement component.

The container preferably comprises a flexible pouch made of a material that melts at a temperature at or above a threshold temperature, or at least about 150 degrees C. or at least about 170 degrees C. or about 171 degrees C. The container comprises a liquid configured to absorb heat from the thermal runaway region sufficiently to quench the thermal runaway and/or terminate propagation of the thermal runaway to neighboring battery cells. The liquid may comprise an electrically non-conductive, minimally conductive, or conductive fluid, and has a boiling point between about 70° C. and about 130° C., or about 80° C. to about 120° C., or about 95° C. to about 105° C.

In an exemplary embodiment, the liquid comprises water or a water solution with additives, such as an aqueous solution or surfactant. In some embodiments, the liquid may include an additive that causes the liquid to have a freezing point below about −10° C., or below about −20° C., or below about −30° C. In one embodiment, the additives comprise a substance or material selected to distribute the water solution from the flexible container at a controlled rate. For example, the additives may be configured to reduce the rate of egress of the water solution from the flexible container after a portion of the container has melted and created an opening for the liquid to flow through. This ensures that the water solution absorbs a substantial amount of heat from the runaway condition. In one embodiment, the water additives are selected to increase the viscosity of the water to greater than about 0.01 poise at 20° C.

In various embodiments, the battery cells are arranged in a row within the housing with a first battery cell at a first end of the row and a second battery cell at a second end of the row opposite the first end. The flexible container extends from the first battery cell to the second battery cell adjacent to the positive terminal of each of the battery cells. Alternatively, the battery module may comprise a plurality of flexible containers that, when combined, extend from one end of the battery row to the other.

In one embodiment, the module further comprises an adhesive between the flexible container and the reinforcement substrate to bond the container to the substrate. The reinforcement substrate may be secured to, for example, the inner surface of the wall of the battery module housing to retain both the sheet and the container therein. In another embodiment, the reinforcement substrate may comprise the inner surface of the battery housing, or another internal component of the housing.

In another embodiment, the reinforcement substrate is disposed within the flexible container. The sheet is preferably bonded to an upper surface of the flexible container, and the liquid resides between the substrate and the lower surface of the container to allow the liquid to quench a thermal runaway event at the positive terminal of the battery cells below the container.

In another embodiment, the battery module comprises a first compartment bonded to a second compartment. The reinforcement substrate is disposed within the first compartment and the flexible container is disposed within the second compartment. The second compartment is preferably disposed between the battery cells and the first compartment.

In another embodiment, the battery module comprises a separate inner container within the housing. The reinforcement substrate and the flexible container are both disposed within the inner container. The flexible container is disposed between the substrate and the battery cells.

In various embodiments, the battery module comprises at least one vent in the housing for venting fluid or gas. In an exemplary embodiment, the vent comprises a membrane having a porosity sufficient to allow passive release of gases from the housing. The vent may further include a mechanical element configured to perforate the membrane at a threshold pressure.

The vent is preferably disposed in one of the sidewalls of the housing, or in a transverse or perpendicular orientation relative to the longitudinal axis of the battery cells. The module may include one or more horizontal channels in the interior of the module and extending from one or more of the positive battery terminals to the vent. This allows any heat, vapor or fluids released from a battery cell to vent in a substantially transverse or horizontal direction relative to the positive and negative terminals of the cells.

In another aspect, a battery module comprises a housing comprising an upper wall and a lower wall. The housing comprises a plurality of lithium-ion battery cells each having a positive terminal facing the upper wall and a negative terminal facing the lower wall. The module further comprises a flexible container housing a liquid and positioned between the upper wall of the housing and the positive terminal of at least one of the battery cells. The flexible container comprises a material configured to melt at a temperature at or above a threshold temperature.

The battery cells in the module are oriented vertically such that a thermal runaway condition will most likely occur through the positive terminal of the battery cell and upwards toward the flexible container. This configuration allows the flexible container to quickly rupture and quench the battery cell that has undergone thermal runaway, thereby inhibiting the thermal runaway from propagating to other cells.

In various embodiments, the plurality of battery cells are arranged in a row within the housing with a first battery cell at a first end of the row and a second battery cell at a second end of the row opposite the first end. The flexible container extends from the first battery cell to the second battery cell adjacent to the positive terminal of each of the battery cells. Alternatively, the battery module may comprise a plurality of flexible containers that, when combined, extend from one end of the battery row to the other.

The flexible container may be secured to the upper wall of the battery module. In some embodiments, the battery module further comprises a reinforcement substrate coupled to the flexible container to provide additional structural rigidity and to inhibit thermal runaway eject from passing therethrough to other battery modules within the battery pack.

In various embodiments, the battery module comprises at least one vent in the housing for venting fluid or gas. In an exemplary embodiment, the vent comprises a membrane having a porosity sufficient to allow passive release of gases from the housing. The vent may further include a mechanical element configured to perforate the membrane at a threshold pressure.

The vent is preferably disposed in one of the sidewalls of the housing, or in a transverse or perpendicular orientation relative to the longitudinal axis of the battery cells. The module may include one or more horizontal channels in the interior of the module and extending from one or more of the positive battery terminals to the vent. This allows any heat, vapor or fluids released from a battery cell to vent in a substantially horizontal direction relative to the positive and negative terminals of the cells.

In another aspect, a battery pack for energy storage comprises a plurality of battery modules stacked in a substantially vertical direction relative to each other. Each of the battery modules comprise a housing comprising an upper wall and a lower wall. The housing comprising a plurality of lithium-ion battery cells each having a positive terminal facing the upper wall and a negative terminal facing the lower wall. Each of the modules further comprise a flexible container housing a liquid and positioned between the upper wall of the housing and the positive terminal of at least one of the battery cells. The flexible container comprises a material configured to melt at a temperature at or above a threshold temperature.

In various embodiments, the battery pack further includes a power management module coupled to at least one of the battery modules. The power management module may comprise any suitable processor and/or electrical circuit for monitoring the battery modules and optimizing battery cell performance. The power management module may also be designed to control the state of charge of each battery cell or module within battery pack and prevent the battery pack from operating outside of the manufacturer's cell ratings, such as current, voltage and/or temperature limits.

### BRIEF DESCRIPTION OF THE DRAWINGS

The accompanying drawings, which are incorporated in and constitute a part of this specification illustrate several embodiments of the disclosure and together with the description, explain the principles of the disclosure.

FIG. 1A is a perspective view of a battery pack comprising a stack of battery modules;

FIG. 1B is a perspective view of one of the for the battery modules of FIG. 1A;

FIG. 1C is a front view of a battery module;

FIG. 1D is a rear view of the battery module;

FIG. 2 is a front view of another battery pack comprising a stack of battery modules;

FIG. 3 is a perspective view of another embodiment of a battery pack comprising multiple stacks of battery modules;

FIG. 4 is an exploded view of a battery module;

FIG. 5 is an enlarged view of one portion of the battery module of FIG. 4;

FIG. 6A is a perspective view of a power management module for one of the battery packs described herein;

FIG. 6B is an exploded view of the power management module of FIG. 6A;

FIG. 7A is a perspective view of another battery pack;

FIG. 7B illustrates the battery pack of FIG. 7A with the front cover removed;

FIG. 7C is a rear view of the battery pack of FIG. 7A;

FIG. 7D is an exploded view of the battery pack of FIG. 7A

FIG. 8 is a side partial cross-sectional view of one portion of a battery module;

FIG. 9A is a side sectional view of an anti-propagation device for the battery module of FIG. 8

FIG. 9B is another embodiment of an anti-propagation device;

FIG. 9C is another embodiment of an anti-propagation device; and

FIG. 9D is another embodiment of an anti-propagation device.

### DESCRIPTION OF THE EMBODIMENTS

This description and the accompanying drawings illustrate exemplary embodiments and should not be taken as limiting, with the claims defining the scope of the description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

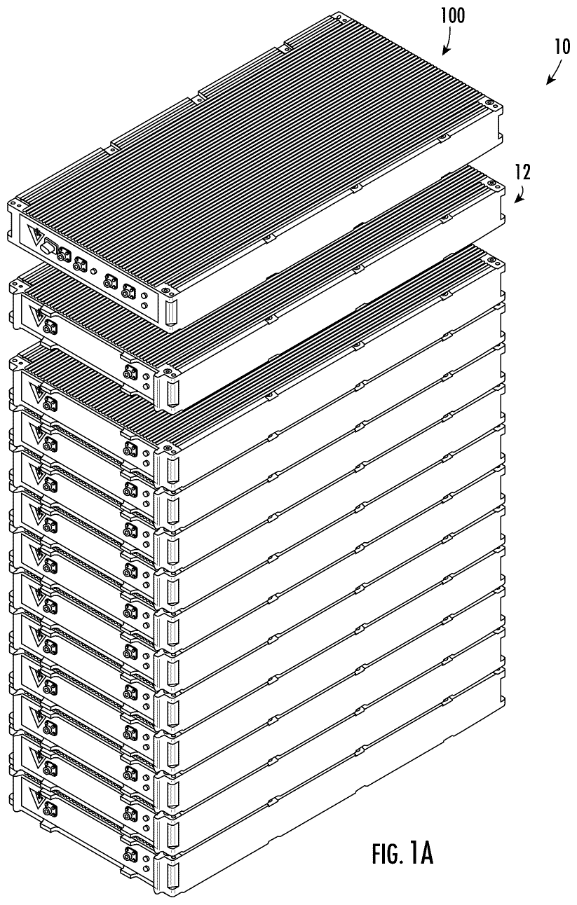

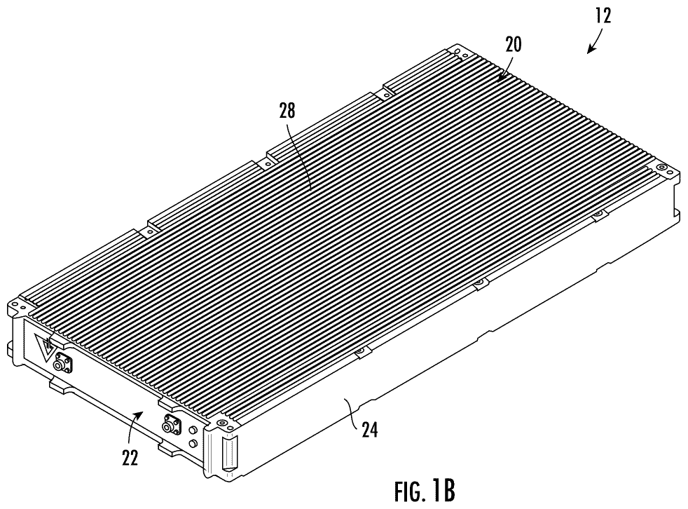

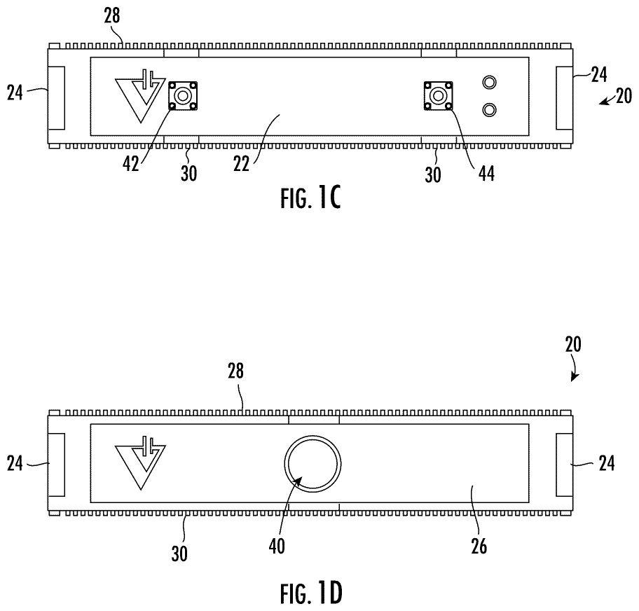

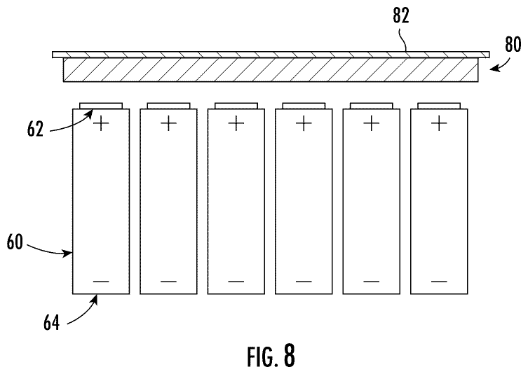

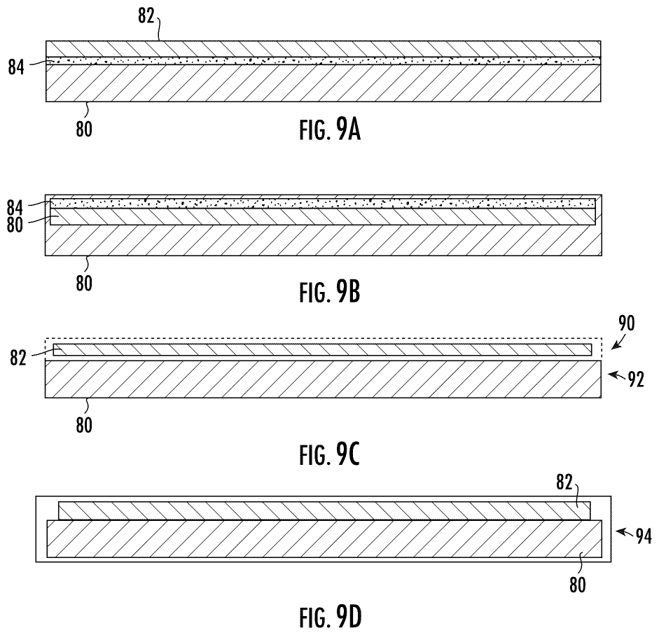

FIGS. 1-7D depict exemplary embodiments of representative battery packs that include a thermal runaway anti-propagation system as described herein and illustrated in FIGS. 8 and 9A-9D. While the anti-propagation systems, devices and methods described herein are presented with respect to the representative battery modules shown in FIGS. 1-7D, it should be understood that these devices, systems and methods may be readily adapted for use with a variety of different types of batteries, battery modules and battery packs, including mobile and large scale energy storage systems, drive systems for equipment and machines, emergency power backup systems, computing devices, such as computers, mobile electronic devices and the like, portable power packs, electric vehicles and others. For example, the thermal runaway anti-propagation system described herein may also be used with any of the battery modules or battery packs described in commonly assigned U.S. Pat. Nos. 18,498,728, 17,933,966, 17,933,976 and 18,332,113, the complete disclosures of which are incorporated herein by reference for all purposes. In addition, the features of the presently described systems and methods may be readily adapted use with a variety of different types of batteries, such as lithium-ion batteries, including lithium iron phosphate (LFP), lithium nickel manganese cobalt (NMC), lithium nickel cobalt aluminum oxide (NCA), lithium-ion manganese oxide (LMO), lithium-ion cobalt oxide (LCO), lithium titanate oxide (LTO) and the like.

As shown in FIG. 1A, battery pack 10 includes a plurality of battery modules 12 stacked on top of each other in a substantially vertical orientation. Battery pack 10 may include at least one module 12, or between about one module to about 50 modules, or between about one module to about 16 modules, or about one module to about 4 modules. The modules 12 may be mechanically coupled to each other in any suitable manner, or they may be simply stacked onto each other without any coupling element. In the preferred embodiment, the battery modules 12 are each composed of a plurality of lithium-ion battery cells.

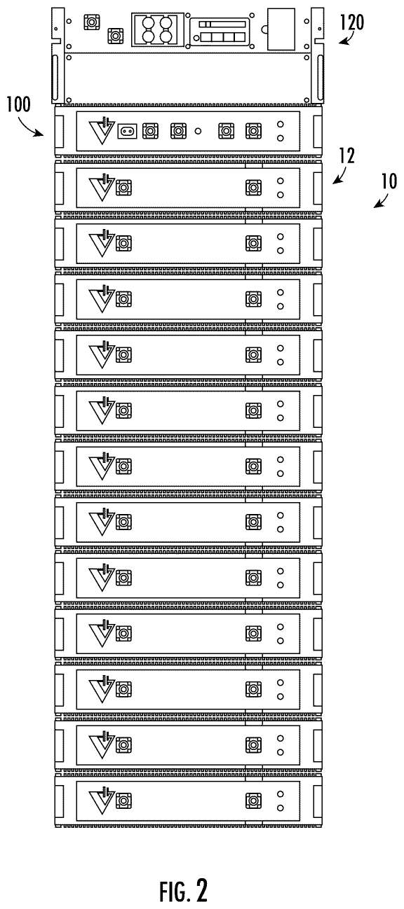

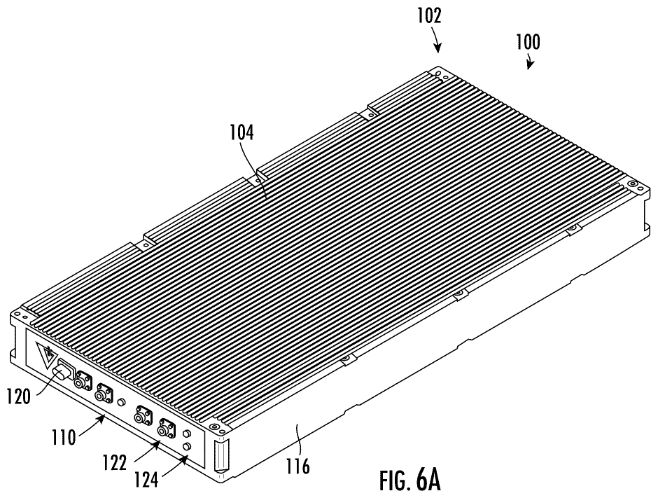

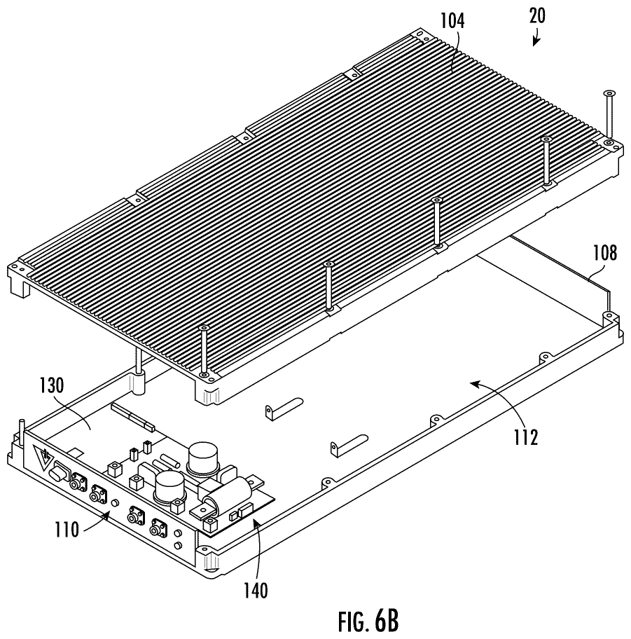

Battery pack 10 comprises suitable electrical connections for enabling the exchange of electrical power for alternatively charging and discharging each module 12 in the array of modules in pack 10. Battery pack 10 may further comprise a power management module 100 positioned at the top of the stack of modules 12 (discussed below in reference to FIGS. 6A and 6B). Alternatively, power management module 100 may be positioned at the bottom of the stack of modules 12, or anywhere between two adjacent modules 12 within the stack. Power management module 100 controls the battery pack 10, enabling internal charging and discharging of batteries. In some embodiments, battery pack 10 may include a power converter or inverter 120 that may be, for example, stacked on top of power management module 100 or positioned in another suitable location within the stack of modules 12 (see FIG. 2) or elsewhere in the energy storage system. Inverter 120 may be connected, for example via any suitable electrical connection. In some embodiments, configurations are employed where multiple battery packs can be connected in series so that the same connector provides communications link to the remote battery pack BMS (not shown).

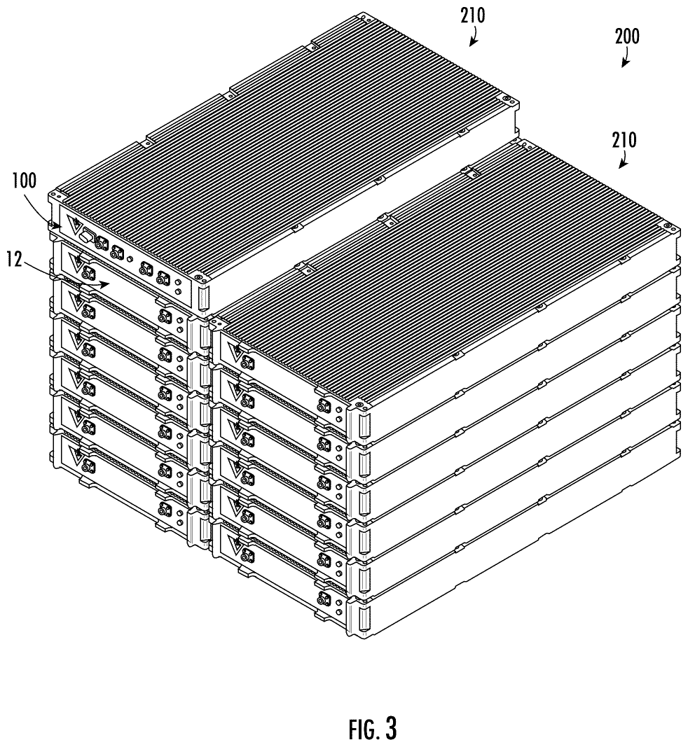

In certain embodiments, a battery pack 200 may comprise two or more vertical stacks 210 of battery modules (see FIG. 3). Each vertical stack 210 may be mechanically coupled to an adjacent stack 210, or it may be arranged adjacent to, or near, the adjacent stacks. Battery pack 200 may include a power management module 100 arranged on top of one of the vertical stacks 210 to control operation of both vertical stacks 210, or it may contain multiple power management modules (i.e., one for each stack).

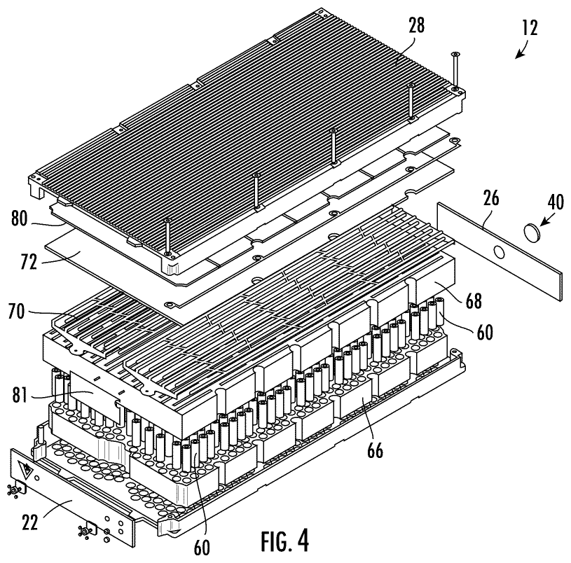

As shown in FIGS. 1B-1D, each battery module 12 comprises a sealed enclosure 20 for retaining a plurality of battery cells 60 (see FIG. 4). Enclosure 20 includes a front plate 22, side plates 24, back plate 26, a top plate 28 and a bottom plate 30, thereby enclosing the array of battery cells 200. Module 12 may further include an electronic lid gasket (not shown) for sealing the volume enclosing the electronics components therein.

Enclosure 20 further includes a burst vent 40 in back plate 26 for venting gases from enclosure 20. In an exemplary embodiment, burst vent 40 comprises a membrane having a porosity sufficient to allow passive release of gases from the housing. In one embodiment, the membrane comprises a suitable gas filtration material, such as polytetrafluoroethylene (PTFE) or the like, that allows gases to pass through for pressure equalization, while also preventing contaminants from entering enclosure 20. The vent 40 may further include a mechanical element configured to perforate the membrane at a threshold pressure to allow rapid degassing during a thermal runaway event, when the gas is expanding at a rate the PTFE membrane cannot passively equalize. Thus, burst vent 40 prevents enclosure 20 from exceeding a pressure that would cause catastrophic failure during a thermal runaway even, when gases and high temperatures are generated rapidly.

Enclosure 20 may further comprise one or more connectors, such as a positive receptacle 42, HVDC (High Voltage Direct Current) connection, and a socket flange. The HVDC connection 42 connects to the positive side of the battery pack. Next to it is an HVDC connection 44 for the negative side. Dust caps are used during transportation only to keep the connectors sealed from dust and moisture.

Referring now to FIG. 4, each battery module 12 comprises a plurality of battery cells 60 oriented vertically such that a positive terminal 62 of each cell 60 faces upper plate 28 and a negative terminal 64 of each cell 60 faces lower plate 30 (positive and negative terminals 60, 62 are shown more clearly in FIG. 8). Each battery module 12 may comprise about 24 to about 2,000 or more individual battery cells. In some embodiments, the cells 60 may be grouped into subunits of about 4 to about 100 cells. Each subunit may contain battery cells 60 positioned adjacent to each other, and may be spaced from adjacent subunits within the module 12. Alternatively, all of the battery cells 60 within each module 12 may be spaced equally from each other throughout the module. Battery cells 60 may be in series, parallel or parallel-series connection.

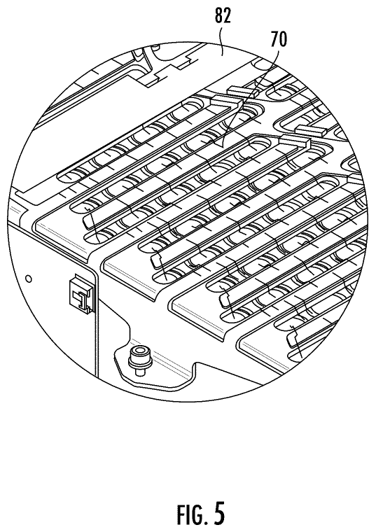

Battery cells 60 are each positioned within an opening in a matrix of filler material 66 positioned on lower plate 30. The filler material 66 may comprise any suitable material, such as a mold in place silicone based thermal material or a pre-formed high temperature foam material, such as Solimide® or the like. The filler material 66 may also be omitted such that only air resides between the battery cells. A frame 68 may be positioned between cells 60 and upper plate 28. A series or array of electrical connectors, such as busbars 70, are positioned above frame 68 for cooperating with the electrical connections (not shown) in a conventional manner to enable the exchange of electrical power for alternately charging and discharging each module 12 in the array. The busbars may include conventional bus bar covers and a copper braid (not shown). Additional filler material 72 is positioned between busbars 70 and upper plate 28. Alternatively, filler material 72 may be omitted from module 12 so that the busbars are not covered, or filter material 72 may comprise a suitable electrically insulating material. Module 12 may further comprise a flex sensing cell module 82 positioned adjacent busbars 70 (see FIG. 5).

A liquid container 80 is positioned between filler material 72 and upper plate 28 (discussed in more detail below in reference to FIG. 8). Liquid container 80 may be coupled or secured to a reinforcement plate 82 (see FIG. 8).

In certain embodiments, battery pack 10 includes one or more pressure monitoring sensors (not shown) for detecting an increase in air pressure within the sealed enclosures 20 of each battery module 12 associated with gas released from a thermal runaway event in one or more of the battery cells 60. The pressure monitoring sensors may be connected to a port (not shown) on the lid of enclosure 20 exterior to the battery pack to allow for calibration and service of the sensors, if needed. The port (not shown) may be in fluid communication with the interior of the enclosure 20 and fluidly connected to the pressure monitoring sensor for transmitting a pressure spike from an increase in internal pressure resulting from a thermal runaway event in one of the modules 12. In certain embodiments, the pressure sensor is mounted internally within the battery pack 10.

In other embodiments, the pressure sensor or switch may be mounted eternally and connected to a port located on one of the enclosures 20. In these embodiments, the pressure switches may be the Dwyer Series 1950, explosion-proof 15 differential pressure switches sold by Dwyer Instruments, Inc. of Michigan City, Indiana, preferably a Dwyer 1950P-2-2F or an-Omega PSW-152 sold by Omega Engineering Inc. of Norwalk, Connecticut. Both pressure switches have LOW- and HIGH-pressure ports. The HIGH-pressure port is connected to the battery pack lid via copper tubing and the LOW-pressure port is left open to atmospheric pressure. A more complete description of a suitable pressure monitoring mechanism can be found in commonly assigned, co-pending U.S. application Ser. No. 17/933,976, the complete disclosure of which is incorporated herein by reference for all purposes.

Referring now to FIGS. 6A and 6B, power management module 100 comprises a sealed enclosure 102 for retaining a battery management unit (BMU) 130, contactors, current sensors, and a fuse 140 for protecting the electrical circuit from overcurrent or excess current due to short circuits and/or electrical faults. BMU 130 may comprise any suitable processor and/or electrical circuit for monitoring battery modules 12 and optimizing battery cell performance. BMU 130 may also be designed to control the state of charge of each battery cell or module within battery pack 10 and prevent the battery pack from operating outside of the manufacturer's cell ratings, such as current, voltage and/or temperature limits. In some embodiments, BMU 130 may be connected wirelessly, or wired, to a remote computing device or processor for reporting the operational status

Enclosure 102 includes a front plate 110, side plates 116, back plate 108, a top plate 104 and a bottom plate 112. Module 12 may further include an electronic lid gasket (not shown) for sealing the volume enclosing the electronics components therein. Module 100 further includes input connectors 122 for coupling battery modules 12 to the module 100. Module 100 also includes one or more module communication connectors 124 which communicate between the power management module 100 and cell modules 12. The power management module also includes an external communication port for communication with inverters and other external devices.

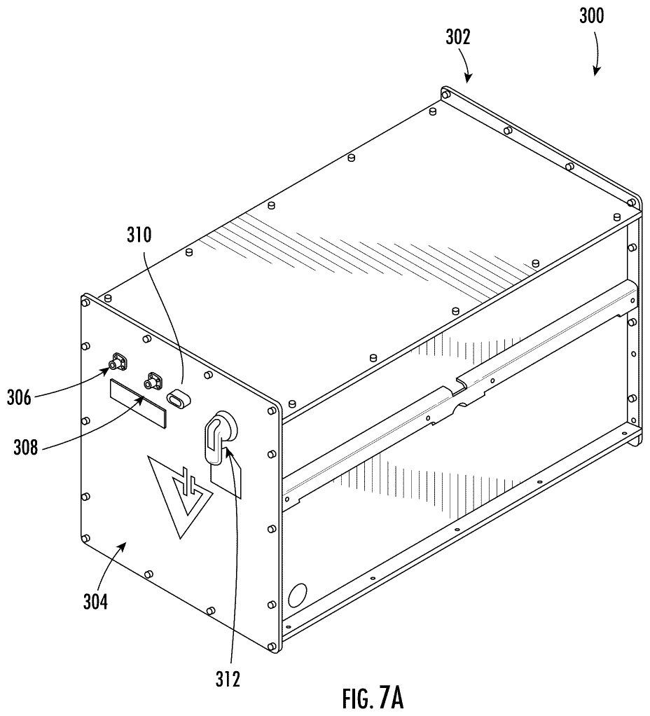

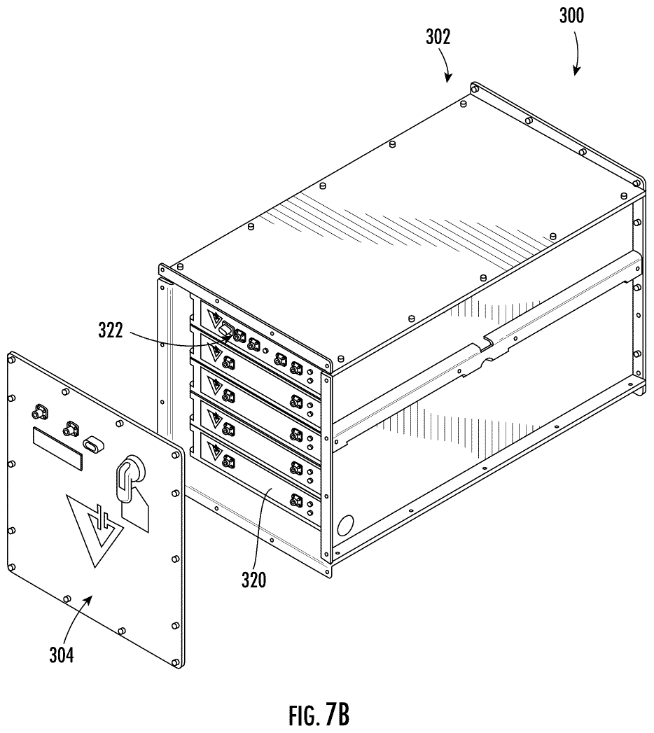

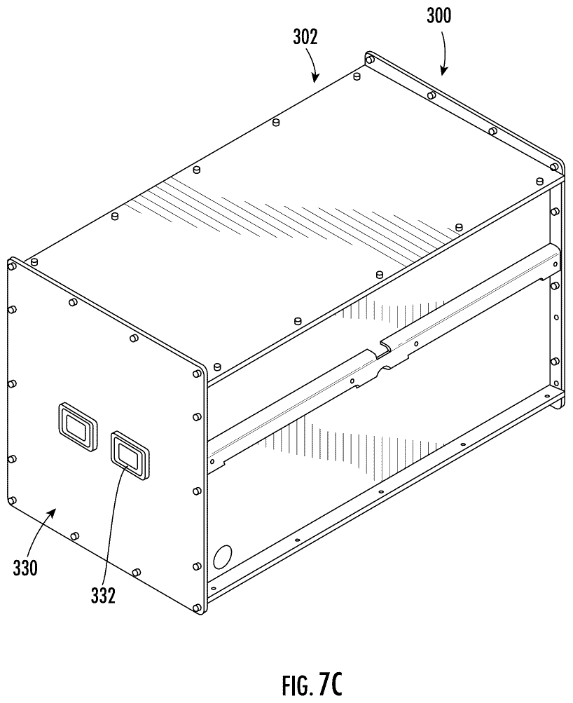

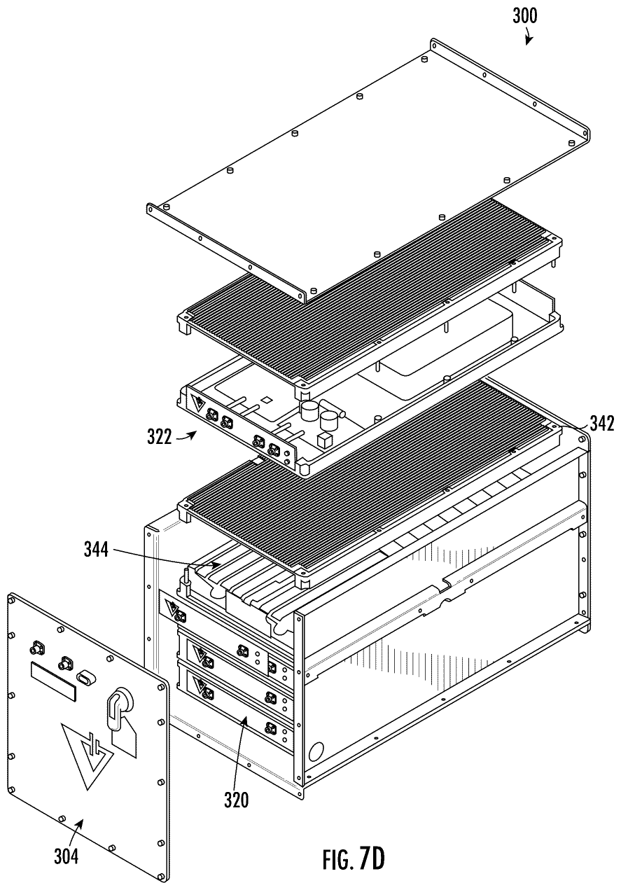

Referring now to FIGS. 7A-7D, another embodiment of a battery pack 300 comprises an outer enclosure 302 that houses a plurality of battery modules 320 and a power management module 322. Enclosure 302 comprises a front plate 304 that may be removed from enclosure 302 to access the internal modules and one or more output connectors 306, 308. Front plate 304 further comprises a port 310 for external communications and DC power for BMU 130, and another port 312, which functions as an HVDC manual electric service disconnect with one side connected to the BMS HVDC output and the other to output connectors 306, 308. Enclosure 302 further includes a back plate 330 with one or more ventilation ports 330, 332.

As shown in FIG. 7D, battery pack 300 comprises a series or array of electrical connectors 344, such as busbars or electrical cables, for cooperating with the electrical connections (not shown) in a conventional manner to enable the exchange of electrical power for alternately charging and discharging each module 320 in the array. The busbars may include conventional bus bar covers and a copper braid (not shown). Battery pack 300 includes an upper plate 342 between electrical connectors 344 and power management module 322 for sealing and protecting the electrical connectors.

With particular reference to FIGS. 8 and 9A-9D, each battery module within a battery pack may comprise an anti-propagation system for thermal runaway. Thermal runaway is defined herein as an increase in temperature that changes the conditions of an individual battery cell in a way that causes a further increase in temperature (or the point wherein the heat generated within the battery cell exceeds the amount of heat that is dissipated to its surroundings). Generally, if the cause of heat is not remedied, the internal battery temperature will continue to rise until it begins to affect adjacent batteries cells within the module causing a chain reaction.

The anti-propagation system preferably comprises one or more liquid containers or pouches 80 associated with each of the plurality of battery modules 12. The liquid pouches 80 comprise a flexible material that has a melting temperature low enough to melt at a threshold temperature, or at least about 150 degrees C. or at least about 170 degrees C. or about 171 degrees C. Suitable materials for liquid pouches 80 include, but are not limited to, low-permeable films, such as polyethylene terephthalate (PET) or the like. In some embodiments, the PET material may be laminated to another layer, such as for example, aluminum foil or the like.

Liquid pouches 80 each include a thermal cooling fluid that ruptures into the associated respective battery module from heat produced in a thermal runaway event in the battery module. The thermal cooling fluid may be electrically non-conductive, minimally conductive, or conductive, and it should have a boiling point between about 70° C. and about 130° C., or about 80° C. to about 120° C., or about 95° C. to about 105° C.

Liquid pouches 80 are preferably composed of water-based coolant that may include one or more additives, such as an aqueous solution or surfactant. In certain embodiments, the liquid may comprise one or more additive that reduce its freezing point to below about −10° C., or below about −20° C., or below about −30° C. The amount of coolant within each pouch 80 can be predefined based on the amount of energy to be dissipated. Once released from its container, the coolant's temperature will increase by absorbing sensible heat from the affected area, thereby cooling it down. When the coolant's temperature reaches the boiling point, the latent energy or phase change energy required to convert the coolant from liquid to vapor will also be absorbed from the affected area thereby cooling it down even further. The latent energy required to vaporize (boil) water is roughly seven times higher than the sensible energy required to heat the water from room temperature to the boiling point. The combined effect of absorbing the released coolant's sensible and latent heat from the affected area will cool down the thermal runaway region sufficiently to quench the thermal runaway and/or terminate propagation of the thermal runaway to neighboring battery cells 60 and modules, thereby protecting any nearby battery cells 60 from thermal runaway thus preventing a dangerous cascade situation.

In an exemplary embodiment, the additives comprise a substance or material configured to distribute the coolant at a controlled rate. In one embodiment, the additive(s) are selected to reduce the rate of egress of the water solution from the flexible container after a portion of the container has melted and created an opening for the liquid to flow through. This ensures that the water solution absorbs a substantial amount of heat from the runaway condition. In one embodiment, the additives are selected to increase the viscosity of the water within pouches 80 to reduce the mass flow rate of the coolant exciting the pouches. The additives are preferably selected such that the coolant exits at a mass flow rate that is high enough to quench a thermal runaway (i.e., not too slow that the thermal runaway propagates to adjacent battery cells before the coolant reduces the temperature), but low enough to ensure that the coolant does not exit too quickly before the thermal runaway has been completely quenched. In an exemplary embodiment, the additives preferably comprise a material that increases the viscosity of the water to greater than about 0.01 poise at 20° C.

In an alternative embodiment, pouches 80 may include a wicking material for distributing the coolant, such as Nomex, Kevlar or carbon fibers, disposed within pouches 80, as described in U.S. Pat. Nos. 11,018,397, 10,734,302, 10,727,462 and 7,144,624, the complete disclosures of which are incorporated herein by reference for all purposes.

Pouches 80 are positioned above the positive terminals 62 of battery cells 60. It should be noted that although battery cells 60 are depicted with a substantially cylindrical shape, the anti-propagation system described herein may be used with cells having a variety of different form factors and shapes, such as prismatic cells with triangular ends, rectangular cells, and the like.

Pouches 80 may be adjacent to the positive terminals or spaced away from terminals 62. In an exemplary embodiment, pouches 80 are spaced above terminals on the other side of frame 68 and the electrical connections (e.g., busbars 70), as shown in FIG. 4. In one embodiment, each battery module 12 comprises a single pouch 80 that extends across and above all of the battery cells 60 within the module. In other embodiments, each battery module 12 may comprise a plurality of individual pouches 80 that are arranged such that each battery cell 60, or a subgrouping of battery cells, contains an overlying pouch.

Pouches 80 are preferably secured to one or more reinforcement plates or sheets 82. Sheets 82 preferably comprise a substantially rigid material that provides structural rigidity to the flexible pouches 80 and prevents thermal runaway ejecta from proceeding through the battery module 12. Thus, sheets 82 provide physical and thermal barriers between pouches 80 and upper plate 28 during the thermal runaway event in battery module 12. Sheets 82 serve as a thermal barrier that absorbs heat via combustion and decomposes into carbon. Sheets 82 may comprise any suitable material that is substantially electrically non-conductive, non-combustible and produces little to no smoke and has low toxicity. The sheet preferably has a self-ignition temperature of greater than about 500° C., or greater than about 600° C. or greater than about 1,000° C. For example, the sheets 82 are formed of a suitably heat resistant material, such as, but not limited to, paper-phenolic laminate, fabric-phenolic laminate, ceramic or glass fiber laminate, carbon fiber laminate, ceramic or glass fiber paper, or other thermal insulating materia, or a combination thereof. In an exemplary embodiment, sheets 82 comprises a phenolic material, such as a phenolic resin.

In other embodiments, the reinforcement substrate, plates or sheets 82 may comprise another substantially rigid material, such as metal, hard plastic or the like. The rigid material may include a coating or thin layer of heat resistant material. In an exemplary embodiment, the rigid material comprises a component of the housing of battery module 12, such as an interior wall of the housing, or an interior partition, layer or sheet within the housing. In one such embodiment, the flexible container is directly adhered to an inner surface of the housing, such that the housing serves as the reinforcement component.

Sheets 82 may be any suitable shape, such as rectangular, cylindrical, circular, square or the like, depending on the shape of the battery module. The sheets 82 can allow one of the TRS pouches 80 to rupture and quench the battery module 12 but can protect another of the TRS pouches 80 from prematurely rupturing unless the heat in the battery module 12 is sufficiently high that a second pouch is required to extinguish the flame. Thus, sheets 82 only allow a sufficient amount of cooling fluid to be released without wasting.

Sheets 82 may be secured to pouches 80 in any suitable manner. In an exemplary embodiment, each sheet 82 is bonded to a pouch 80 with an adhesive 84 (see FIG. 9A). Suitable adhesives include, but are not limited to, pressure sensitive adhesives and the like.

FIGS. 9B-9D illustrates alternative embodiments for bonding sheets 82 to pouches 80. As shown in FIG. 9B, sheet 82 may be positioned within pouch 80 and adhered to the upper or lower wall of pouch 80 with an adhesive 84. In a preferred embodiment, sheet 82 is adhered to the upper wall of pouch 80 such that the liquid within pouch is disposed between sheet 82 and the battery cells 60.

FIG. 9C illustrates another embodiment that comprises upper and lower compartments 90, 92 that are bonded to each other with, for example, a suitable adhesive. In this embodiment, sheet 82 is housed within upper compartment 90 and pouch 80 is housed within lower compartment 92. FIG. 9D illustrates yet another embodiment that comprises a single outer compartment 94 that houses both sheet 82 and pouch 80. Compartments 90, 92 and 94 may be formed of any suitable material that has a melting temperature low enough to melt at a threshold temperature, or at least about 150 degrees C. or at least about 170 degrees C. or about 171 degrees C.

As discussed previously in reference to FIGS. 1A-1D, each battery module 12 includes a vent 40 for venting gases from the module. In certain embodiments, modules 12 further comprise one or more horizontal channels or passages (not shown) extending through module 12 from the positive terminals 62 to vent 40. These channels may, for example, extend between positive terminals 62 and liquid pouches 80, and function to direct the hot effluent and heated water vapor horizontally through module towards vent 40 to allow pressure to be released and enable hot gasses to escape. This ensures that surrounding battery cells remain cool after a thermal runaway condition is quenched. The channels may extend through the interior of modules 12, and/or they may extend along the inside portion of each side of the modules. Each module 12 may include any desired number of horizontal channels.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a battery module comprising a housing comprising a plurality of lithium-ion battery cells each having a positive terminal and a negative terminal and a flexible container housing a liquid and positioned adjacent to the positive terminal of at least one of the battery cells. The flexible container comprises a material configured to melt at a temperature at or above a threshold temperature. The battery module further comprises a reinforcement sheet in contact with the flexible container.

A second embodiment is the first embodiment, wherein the reinforcement sheet is bonded to the flexible container.

A third embodiment is any combination of the first two embodiments, wherein the flexible container is disposed between the reinforcement sheet and the battery cells.

A 4^{th} embodiment is any combination of the first 3 embodiments, wherein the battery cells are arranged in a row within the housing with a first battery cell at a first end of the row and a second battery cell at a second end of the row opposite the first end.

A 5^{th} embodiment is any combination of the first 4 embodiments, wherein the flexible container extends from the first battery cell to the second battery cell adjacent to the positive terminal of each of the battery cells.

A 6^{th} embodiment is any combination of the first 5 embodiments, wherein the flexible container is spaced from the positive terminals of the battery cells.

A 7^{th} embodiment is any combination of the first 6 embodiments, further comprising a plurality of flexible containers positioned between an upper wall of the housing and the positive terminals of the battery cells.

An 8^{th} embodiment is any combination of the first 7 embodiments, further comprising an adhesive between the flexible container and the reinforcement sheet.

A 9^{th} embodiment is any combination of the first 8 embodiments, wherein the reinforcement sheet is disposed within the flexible container.

A 10^{th} embodiment is any combination of the first 9 embodiments, further comprising a first compartment bonded to a second compartment, wherein the reinforcement sheet is disposed within the first compartment and the flexible container is disposed within the second compartment.

An 11^{th} embodiment is any combination of the first 10 embodiments, further comprising an outer container, wherein the reinforcement sheet and the flexible container are disposed within the outer container.

A 12^{th} embodiment is any combination of the first 11 embodiments, wherein the reinforcement sheet is substantially rigid.

A 13^{th} embodiment is any combination of the first 12 embodiments, wherein the reinforcement sheet is electrically non-conductive.

A 14^{th} embodiment is any combination of the first 13 embodiments, wherein the reinforcement sheet has a self-ignition temperature of at least about 500° C.

A 15^{th} embodiment is any combination of the first 14 embodiments, wherein the reinforcement sheet comprises a phenolic material.

A 16^{th} embodiment is any combination of the first 15 embodiments, further comprising at least one vent in the housing for venting fluid or gas.

A 17^{th} embodiment is any combination of the first 16 embodiments, wherein the vent comprises a membrane having a porosity sufficient to allow passive release of gases from the housing.

An 18^{th} embodiment is any combination of the first 17 embodiments, wherein the vent comprises a mechanical element configured to perforate the membrane at a threshold pressure.

A 19^{th} embodiment is any combination of the first 18 embodiments, wherein the battery cells define a length from the positive terminal to the negative terminal and the vent is oriented at a transverse direction to said length.

A 20^{th} embodiment is any combination of the first 19 embodiments, wherein the flexible container comprises a pouch.

A 21^{st} embodiment is any combination of the first 20 embodiments, wherein the liquid has a boiling point between about 70° C. and about 130° C.

A 22^{nd} embodiment is any combination of the first 21 embodiments, wherein the liquid has a freezing point of less than about −10° C.

A 23^{rd} embodiment is any combination of the first 22 embodiments, wherein the liquid comprises water.

A 24^{th} embodiment is any combination of the first 23 embodiments, wherein the water comprises one or more additives that increase a viscosity of the water to greater than 0.01 poise at 20° C.

A 25^{th} embodiment is any combination of the first 23 embodiments, wherein the housing comprises an inner surface, wherein the reinforcement substrate is the inner surface and the flexible container is bonded to the inner surface.

A 26^{th} embodiment is any combination of the first 25 embodiments, further comprising a heat resistant coating on the inner surface between the substrate and the inner surface.

In another aspect, a first embodiment is a battery module comprising a housing comprising an upper wall and a lower wall, the housing comprising a plurality of lithium-ion battery cells each having a positive terminal facing the upper wall and a negative terminal facing the lower wall; and a flexible container housing a liquid and positioned between the upper wall of the housing and the positive terminal of at least one of the battery cells, wherein the flexible container comprises a material configured to melt at a temperature at or above a threshold temperature.

A second embodiment is the first embodiment, wherein the plurality of battery cells are arranged in a row within the housing with a first battery cell at a first end of the row and a second battery cell at a second end of the row opposite the first end.

A third embodiment is any combination of the first two embodiments, wherein the flexible container extends from the first battery cell to the second battery cell adjacent to the positive terminal of each of the battery cells.

A 4^{th} embodiment is any combination of the first 3 embodiments, wherein the plurality of battery cells are arranged in first and second adjacent rows withing the housing, and wherein the flexible container is positioned adjacent to the first and second rows.

A 5^{th} embodiment is any combination of the first 4 embodiments, wherein the flexible container is spaced from the positive terminals of the battery cells.

A 6^{th} embodiment is any combination of the first 5 embodiments, further comprising a reinforcement sheet in contact with the container.

A 7^{th} embodiment is any combination of the first 6 embodiments, wherein the reinforcement sheet is bonded to the container.

An 8^{th} embodiment is any combination of the first 7 embodiments, wherein the reinforcement sheet is secured to an inner surface of the housing.

A 9^{th} embodiment is any combination of the first 8 embodiments, further comprising at least one vent in the housing for venting fluid or gas.

A 10^{th} embodiment is any combination of the first 9 embodiments, wherein the vent comprises a membrane having a porosity sufficient to allow passive release of gases from the housing.

An 11^{th} embodiment is any combination of the first 10 embodiments, wherein the vent comprises a mechanical element configured to perforate the membrane at a threshold pressure.

A 12^{th} embodiment is any combination of the first 11 embodiments, wherein the housing comprises sidewalls extending from the upper wall to the lower wall, the vent being disposed in one of the sidewalls.

A 13^{th} embodiment is any combination of the first 12 embodiments, wherein the liquid comprises water.

A 14^{th} embodiment is any combination of the first 13 embodiments, wherein the water comprises one or more additives that increase a viscosity of the water to greater than 0.01 poise at 20° C.

In another aspect, a first embodiment is a battery storage system comprising a plurality of battery modules stacked in a substantially vertical direction relative to each other. Each of the battery modules comprises a housing comprising an upper wall and a lower wall, the housing comprising a plurality of lithium-ion battery cells each having a positive terminal facing the upper wall and a negative terminal facing the lower wall, a flexible container housing a liquid and positioned between the upper wall of the housing and the positive terminal of at least one of the battery cells, wherein the flexible container comprises a material configured to melt at a temperature at or above a threshold temperature and a power management module coupled to at least one of the battery modules.

A second embodiment is the first embodiment, wherein each of the battery modules comprises at least first and second rows of lithium-ion battery cells extending substantially horizontally through the battery module, wherein each of the lithium-ion battery cells comprises a positive terminal facing the upper wall of the battery module and a negative terminal facing the lower wall of the battery module.

A third embodiment is any combination of the first two embodiments, wherein each of the battery modules comprises at least one vent for venting fluid or gas.

A 4^{th} embodiment is any combination of the first 3 embodiments, wherein the vent comprises a membrane having a porosity sufficient to allow passive release of gases from the housing.

A 5^{th} embodiment is any combination of the first 4 embodiments, wherein the vent comprises a mechanical element configured to perforate the membrane at a threshold pressure.

A 6^{th} embodiment is any combination of the first 5 embodiments, wherein the housing comprises sidewalls extending from the upper wall to the lower wall, the vent being disposed in one of the sidewalls.

A 7^{th} embodiment is any combination of the first 6 embodiments, wherein the flexible container is spaced from the positive terminals of the battery cells.

An 8^{th} embodiment is any combination of the first 7 embodiments, further comprising a reinforcement sheet in contact with the container.

A 9^{th} embodiment is any combination of the first 8 embodiments, wherein the reinforcement sheet is bonded to the container.

A 10^{th} embodiment is any combination of the first 9 embodiments, wherein the reinforcement sheet is secured to an inner surface of the housing.

An 11^{th} embodiment is any combination of the first 10 embodiments, further comprising a plurality of flexible containers disposed between the upper wall of the housing and the positive terminals of the battery cells, each of the flexible containers housing a liquid and comprising a material configured to melt at a temperature at or above a threshold temperature.

1. A battery module comprising:
a housing comprising a plurality of lithium-ion battery cells each having a positive terminal and a negative terminal;
a flexible container housing a liquid and positioned adjacent to the positive terminal of at least one of the battery cells, wherein the flexible container comprises a material configured to melt at a temperature at or above a threshold temperature; and
a reinforcement substrate in contact with the flexible container.

2. The battery module of claim 1, wherein the reinforcement substrate is bonded to the flexible container and wherein the flexible container is disposed between the reinforcement substrate and the battery cells.

3. The battery module of claim 1, wherein the battery cells are arranged in a row within the housing with a first battery cell at a first end of the row and a second battery cell at a second end of the row opposite the first end, wherein the flexible container extends from the first battery cell to the second battery cell adjacent to the positive terminal of each of the battery cells within the row.

4. The battery module of claim 3, wherein the flexible container is spaced from the positive terminals of the battery cells.

5. The battery module of claim 1, wherein the reinforcement substrate is disposed within the flexible container.

6. The battery module of claim 1, further comprising a first compartment bonded to a second compartment, wherein the reinforcement substrate is disposed within the first compartment and the flexible container is disposed within the second compartment.

7. The battery module of claim 1, further comprising an outer container, wherein the reinforcement substrate and the flexible container are disposed within the outer container.

8. The battery module of claim 1, wherein the reinforcement substrate has a self-ignition temperature of at least about 500° C.

9. The battery module of claim 1, wherein the reinforcement substrate comprises a phenolic material.

10. The battery module of claim 1, wherein the housing comprises an inner surface, wherein the reinforcement substrate is the inner surface and the flexible container is bonded to the inner surface.

11. The battery module of claim 10, further comprising a heat resistant coating on the inner surface between the substrate and the inner surface.

12. The battery module of claim 1, further comprising at least one vent in the housing for venting fluid or gas, wherein the vent comprises a membrane having a porosity sufficient to allow passive release of gases from the housing.

13. The battery module of claim 12, wherein the vent comprises a mechanical element configured to perforate the membrane at a threshold pressure.

14. The battery module of claim 12, wherein the battery cells define a length from the positive terminal to the negative terminal and the vent is oriented at a transverse direction to said length, the module further comprising one or more substantially horizontal channels extending from the positive terminals of the battery cells to the vent.

15. A battery module comprising:
a housing comprising an upper wall and a lower wall, the housing comprising a plurality of lithium-ion battery cells each having a positive terminal facing the upper wall and a negative terminal facing the lower wall; and
a flexible container housing a liquid and positioned between the upper wall of the housing and the positive terminal of at least one of the battery cells, wherein the flexible container comprises a material configured to melt at a temperature at or above a threshold temperature.

16. The battery module of claim 15, wherein the plurality of battery cells are arranged in a row within the housing with a first battery cell at a first end of the row and a second battery cell at a second end of the row opposite the first end, wherein the flexible container extends from the first battery cell to the second battery cell adjacent to the positive terminal of each of the battery cells in the row.

17. The battery module of claim 15, wherein the plurality of battery cells are arranged in first and second adjacent rows withing the housing, and wherein the flexible container is positioned adjacent to the first and second rows, wherein the flexible container is spaced from the positive terminals of the battery cells.

18. The battery module of claim 15, further comprising a reinforcement sheet in contact with the container, wherein the reinforcement sheet is bonded to the container.

19. The battery module of claim 15, further comprising at least one vent in the housing for venting fluid or gas, wherein the vent comprises a membrane having a porosity sufficient to allow passive release of gases from the housing.

20. The battery module of claim 19, wherein the vent comprises a mechanical element configured to perforate the membrane at a threshold pressure, wherein the housing comprises sidewalls extending from the upper wall to the lower wall, the vent being disposed in one of the sidewalls, the battery module further comprising one or more substantially horizontal channels extending from the positive terminals to the vent.
